(19) United States
(12) Patent Application Publication
(10) Pub. No.: US 2025/0097997 A1
(43) Pub. Date: Mar. 20, 2025

(54) IMPROVEMENTS IN AND RELATING TO LOCAL AREA DATA NETWORK SERVICE INFORMATION

(71) Applicant: Samsung Electronics Co., Ltd., Suwon-si, Gyeonggi-do (KR)

(72) Inventors: Mahmoud WATFA, Staines, Middlesex (GB); Lalith KUMAR, Bangalore (IN)

(21) Appl. No.: 18/291,801

(22) PCT Filed: Jul. 28, 2022
(86) PCT No.: PCT/KR2022/011136

§ 371 Date: Jan. 24, 2024

(30) Foreign Application Priority Data
Jul. 28, 2021 (IN) 202131033908
Aug. 11, 2021 (IN) 202131036296
Jul. 27, 2022 (GB) 2210955.7
Jul. 27, 2022 (GB) 2210956.5

(51) Int. Cl. H04W 76/10; H04W 24/02; H04W 60/04

(52) U.S. Cl. CPC H04W 76/10; H04W 24/02; H04W 60/04

(57) ABSTRACT

The disclosure relates to a 5G or 6G communication system for supporting a higher data transmission rate. Disclosed is a method of operating a user equipment (UE) in communication with a telecommunication network, wherein the UE is provided with a first set of information and a second set of information, the first and second sets relating to the availability of one or more certain services for the UE defined in terms of tracking area Identities (TAIs), wherein the UE determines if there is an overlapping TAI present in the first and the second set of information and, if it is so determined, then a rule associated with whichever of the first and second set has been assigned a higher priority applies to the overlapping TAI.

### CROSS-REFERENCE TO RELATED APPLICATION(S)

This application is a U.S. National Stage application under 35 U.S.C. § 371 of an International application number PCT/KR2022/011136, filed on Jul. 28, 2022, which is based on and claims priority of an Indian Patent Application number 202131033908, filed on Jul. 28, 2021, in the Indian Intellectual Property Office, and of an Indian Patent Application number 202131036296, filed on Aug. 11, 2021, in the Indian Intellectual Property Office, and of a United Kingdom patent application number 2210955.7, filed on Jul. 27, 2022, in the United Kingdom Intellectual Property Office, and of a United Kingdom patent application number 2210956.5, filed on Jul. 27, 2022, in the United Kingdom Intellectual Property Office, the disclosure of each of which is incorporated by reference herein in its entirety.

### TECHNICAL FIELD

The disclosure relates to methods for managing overlap between to Local Area Data Network (LADN) Service Information and other lists.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE

### Technical Problem

An aspect of the disclosure may provide a device for managing overlap between to Local Area Data Network, LADN, Service Information and other lists and an operating method thereof.

### Technical Solution

According to an embodiment, a method of operating a user equipment (UE) in communication with a telecommunication network is provided, and the method comprises receiving a first set of information and a second set of information, the first and second sets relating to the availability of one or more certain services for the UE defined in terms of tracking area Identities (TAIs), determining whether there is an overlapping TAI present in the first and the second set of information, and in case that there is the overlapping TAI present in the first and the second set of information, applying a rule associated with whichever of the first and second set has been assigned a higher priority to the overlapping TAI.

According to an embodiment, a method of operating a user equipment (UE) in communication with a telecommunication network is provided, and the method comprises in case that the UE is in a local area data network (LADN) area and the UE is in a predetermined state, initiating a network access stratum (NAS) procedure, wherein the NAS procedure is one of a 5GSM or 5GMM procedure.

### DESCRIPTION OF DRAWINGS

FIG. 1 shows an illustration where a UE RA and an LADN Service Area that is part of the RA known in the prior art;

FIG. 2 shows an illustration where a UE RA contains a (non-allowed) Service Area known in the prior art;

FIG. 3 shows an illustration where a UE RA with a TAI (#3) that is considered to be an LADN service area and a non-allowed area at the same time, known in the prior art;

FIG. 4 shows a flowchart illustrating a method according to an embodiment of the disclosure;

FIG. 5 is a block diagram schematically illustrating an internal structure of a UE according to an embodiment of the disclosure;

FIG. 6 is a block diagram schematically illustrating an internal structure of a network device according to an embodiment of the disclosure;

FIG. 7 is a diagram schematically illustrating a structure of a network device according to an embodiment of the disclosure; and

FIG. 8 is a view schematically illustrating a structure of a UE according to an embodiment of the disclosure.

### MODE FOR INVENTION

The Fifth Generation System, 5GS, supports connection with a Protocol Data Unit, PDU, session to a data network, DN, that is only accessible in a local area, hence the term Local Area Data Network, LADN. The area that defines the LADN is known as LADN service area, which is defined by a set of tracking areas that is part of the User Equipment's, UE's, current registration area. An LADN is associated with an LADN DNN. The following is specified in 3GPP TS 23.501 V17.1.1:

“LADN Information (i.e. LADN Service Area Information and LADN DNN) is provided by Access and Mobility Management Function, AMF, to the UE during the Registration procedure or UE Configuration Update procedure. For each LADN DNN configured in the AMF, the corresponding LADN Service Area Information includes a set of Tracking Areas, TA, that belong to the Registration Area that the AMF assigns to the UE (i.e. the intersection of the LADN service area and the assigned Registration Area). The AMF shall not create Registration Area based on the availability of LADNs.

NOTE 4: It is thus possible that the LADN Service Area Information sent by the AMF to the UE contains only a sub-set of the full LADN service area, as the LADN service area can contain TA(s) outside of the registration area of the UE or outside of the area served by the AMF.”

The following is specified in 3GPP TS 24.501 V17.3.0 about LADN:

“The UE can receive the local area data network (LADN) information consisting of LADN DNNs and LADN service area information (a set of tracking areas that belong to the current registration area) during the registration procedure or the generic UE configuration update procedure (see subclause 5.5.1 and subclause 5.4.4).

If the UE is not operating in Standalone Non-Public Network, SNPN, access operation mode, the UE considers the received LADN information to be valid only in the Tracking Area Identities, TAIs, of the registered Public Land Mobile Network, PLMN, that are in the LADN service area information, and in the TAIs of the equivalent PLMNs if the LADN service area information includes TAIs for the equivalent PLMNs. When the AMF provides the UE with LADN service area information containing TAIs for the equivalent PLMNs, the AMF shall include these TAIs of the equivalent PLMNs in the UE's registration area.

If the UE is operating in SNPN access operation mode, the UE considers the received LADN information to be valid only in the TAIs of the registered SNPN that are in the LADN service area information.

The LADN DNN(s) received by the UE is also considered as LADN DNN(s) in the equivalent PLMNs.

The UE shall consider itself to be located inside the LADN service area based on the LADN service area information. If the UE does not have a LADN service area information for the LADN DNN, the UE shall consider itself to be located outside the LADN service area.

When the UE is located in the LADN service area, the UE may initiate:
the UE-requested PDU session establishment procedure with a LADN DNN to establish a PDU session for LADN;
the UE-requested PDU session modification procedure to modify the PDU session for LADN; and
the service request procedure to re-establish the user-plane resources for the PDU session for LADN.

When the UE is located outside the LADN service area, the UE is allowed:
to initiate the UE-requested PDU session release procedure to release a PDU session for LADN; or
to initiate the UE-requested PDU session modification procedure to indicate a change of 3GPP Packet-Switch, PS, data off UE status.

If the UE has moved out of the LADN service area, the SMF shall:
a) release the PDU session for LADN; or
b) release the user-plane resources for the PDU session for LADN and maintain the PDU session for LADN;
according to operator's policy.

In case b):
if the UE has returned to the LADN service area, and the network has downlink user data pending, the network re-establishes the user-plane resources for the PDU session for LADN; and.
if the UE has not returned to the LADN service area after a period of time according to operator's policy, the SMF may release the PDU session for LADN.

When the UE moves to 5GMM-DEREGISTERED state, the UE shall delete the stored LADN information, if any.

NOTE: In this release, LADNs apply only to 3GPP access.

Upon inter-system change from NI mode to S1 mode in EMM-IDLE mode, the UE shall not transfer a PDU session for LADN to EPS.”

The excerpts above clearly indicate that a service for LADN can only be accessed if the UE is within the LADN service area. Moreover, when the UE is inside the LADN service area, the UE is allowed to initiate any 5GSM (Session Management) procedure e.g. to establish a PDU session for LADN or to modify an LADN PDU session.

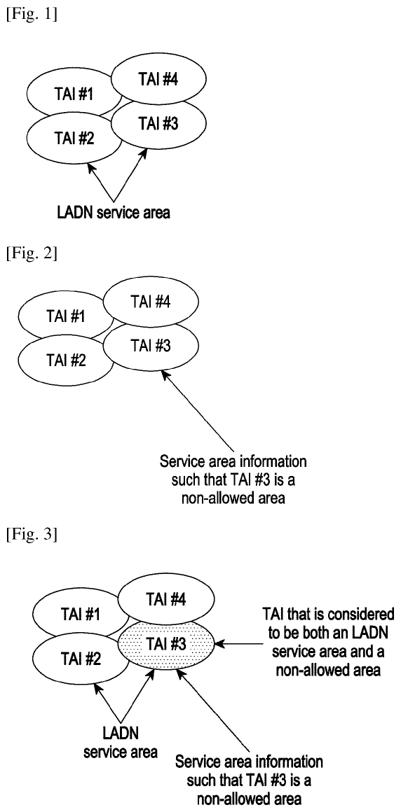

As indicated above, the LADN service area contains tracking areas, TAs, that are part of the UE's registration area. FIG. 1 shows an illustrative example of a UE's registration area, RA, consisting of TAI #1, TAI #2, TAI #3, and TAI #4. Furthermore, the UE's LADN service area is considered to be TAI #2 and TAI #3.

3GPP TS 23.501 and 3GPP TS 24.501 describe the concept of service area restriction which is one type of mobility restriction that are defined in 5GS. The service area restriction is a set of TAIs in which the UE cannot get normal services except for some conditions or cases as described in the aforementioned standard specifications. For example, when the UE is in a non-allowed area (or when the UE is outside of an allowed area), the UE is not allowed to initiate a 5GSM procedure (e.g. to establish a PDU session) or to send a 5GSM message to release a PDU session.

The detailed UE behaviour when it is in a restricted service area is shown below from 3GPP TS 24.501:

“The service area restrictions consist of tracking areas forming either an allowed area, or a non-allowed area. The tracking areas belong to either the registered PLMN or its equivalent PLMNs in the registration area. The allowed area can contain up to 16 tracking areas or include all tracking areas in the registered PLMN and its equivalent PLMN(s) in the registration area. The non-allowed area can contain up to 16 tracking areas. The network conveys the service area restrictions to the UE by including either an allowed area, or a non-allowed area, but not both, in the Service area list IE of a REGISTRATION ACCEPT message or a CONFIGURATION UPDATE COMMAND message.

If the network does not convey the service area restrictions to the UE in the Service area list IE of a REGISTRATION ACCEPT message, the UE shall treat all tracking areas in the registered PLMN and its equivalent PLMN(s) in the registration area as allowed area and delete the stored list of “allowed tracking areas” or the stored list of “non-allowed tracking areas”.

When the UE receives a Service area list IE with an allowed area indication during a registration procedure or a generic UE configuration update procedure:
a) if the “Type of list” included in the Service area list IE does not indicate “all TAIs belonging to the PLMNs in the registration area are allowed area”, the UE shall delete the old list of “allowed tracking areas” and store the tracking areas in the allowed area as the list of “allowed tracking areas”. If the UE has a stored list of “non-allowed tracking areas”, the UE shall delete that list; or
b) if the “Type of list” included in the Service area list IE indicates “all TAIs belonging to the PLMNs in the registration area are allowed area”, the UE shall treat all tracking areas in the registered PLMN and its equivalent PLMN(s) as allowed area and delete the stored list of “allowed tracking areas” or the stored list of “non-allowed tracking areas”.

When the UE receives a Service area list IE with a non-allowed area indication during a registration procedure or a generic UE configuration update procedure, the UE shall delete the old list of “non-allowed tracking areas” and store the tracking areas in the non-allowed area as the list of “non-allowed tracking areas”. If the UE has a stored list of “allowed tracking areas”, the UE shall delete that list.

If the UE is successfully registered to a PLMN and has a stored list of “allowed tracking areas”:
a) while camped on a cell whose TAI is in the list of “allowed tracking areas”, the UE shall stay in, or enter, the state 5GMM-REGISTERED.NORMAL-SERVICE and is allowed to initiate any 5GMM and 5GSM procedures; and
b) while camped on a cell which is in the registered PLMN or a PLMN from the list of equivalent PLMNs and whose TAI is not in the list of “allowed tracking areas”, the UE shall enter the state 5GMM-REGISTERED.NON-ALLOWED-SERVICE, and:
1) if the UE is in 5GMM-IDLE mode or 5GMM-IDLE mode with suspend indication over 3GPP access, the UE:
   i) shall not include the Uplink data status IE in the registration procedure for mobility and periodic registration update except for emergency services or for high priority access;
   ii) shall not perform the registration procedure for mobility and periodic registration update with Follow-on request indicator set to “Follow-on request pending”, except for:
      emergency services;
      high priority access;
      indicating a change of 3GPP PS data off UE status;
      sending an SOR transparent container;
      sending a UE policy container; or
      sending a UE parameters update transparent container;
   iii) shall not initiate a service request procedure or request the lower layers to resume a suspended connection, except for:
      emergency services;
      emergency services fallback;
      high priority access;
      responding to paging;
      responding to notification received over non-3GPP access;
      indicating a change of 3GPP PS data off UE status;
      sending an SOR transparent container;
      sending a UE policy container; or
      sending a UE parameters update transparent container; and
2) if the UE is in 5GMM-CONNECTED mode or 5GMM-CONNECTED mode with RRC inactive indication over 3GPP access, the UE:
   i) shall not perform the registration procedure for mobility and periodic registration update with Uplink data status IE except for emergency services or for high priority access;
   ii) shall not initiate a service request procedure except for:
      emergency services;
      emergency services fallback;
      high priority access;
      responding to paging or responding to notification received over non-3GPP access;
   iii) shall not initiate a 5GSM procedure except for:
      emergency services;
      high priority access; or
      indicating a change of 3GPP PS data off UE status; and
   iv) shall not perform the NAS transport procedure except for the sending:
      SMS;
      an LPP message;
      a location services message;
      an SOR transparent container;
      a UE policy container;
      a UE parameters update transparent container; or
      a CIOT user data container.

NOTE 1: The contents of CIOT user data container can be data that is not for exception reports, or data that is for exception reports if allowed for the UE (see subclause 6.2.13).

If the UE is successfully registered to a PLMN and has a stored list of “non-allowed tracking areas”:
a) while camped on a cell which is in the registered PLMN or a PLMN from the list of equivalent PLMNs and whose TAI is not in the list of “non-allowed tracking areas”, the UE shall stay in, or enter, the state 5GMM-REGISTERED.NORMAL-SERVICE and is allowed to initiate any 5GMM and 5GSM procedures; and
b) while camped on a cell whose TAI is in the list of “non-allowed tracking areas”, the UE shall enter the state 5GMM-REGISTERED.NON-ALLOWED-SERVICE, and:
1) if the UE is in 5GMM-IDLE mode or 5GMM-IDLE mode with suspend indication over 3GPP access, the UE:
   i) shall not include the Uplink data status IE in the registration procedure for mobility and periodic registration update except for emergency services or for high priority access;
   ii shall not perform the registration procedure for mobility and periodic registration update with Follow-on request indicator set to “Follow-on request pending”, except for:
      emergency services;
      high priority access;
      indicating a change of 3GPP PS data off UE status;
      sending an SOR transparent container;
      sending a UE policy container; or
      sending a UE parameters update transparent container; and
   iii) shall not initiate a service request procedure or request the lower
      layers to resume a suspended connection, except for:
      emergency services;
      emergency services fallback;
      high priority access;
      responding to paging;
      responding to notification received over non-3GPP access;
      indicating a change of 3GPP PS data off UE status;
      sending an SOR transparent container;
      sending a UE policy container; or
      sending a UE parameters update transparent container; and
2) if the UE is in 5GMM-CONNECTED mode or 5GMM-CONNECTED mode with RRC inactive indication over 3GPP access, the UE:
   i) shall not perform the registration procedure for mobility and registration update with the Uplink data status IE except for emergency services or for high priority access;
   ii) shall not initiate a service request procedure or request the lower layers to resume a suspended connection, except for:
      emergency services;
      emergency services fallback;
      high priority access; or
      responding to paging or responding to notification received over non-3GPP access;
   iii) shall not initiate a 5GSM procedure except for:
      *127-emergency services;
      high priority access; or
      indicating a change of 3GPP PS data off UE status; and
   iv) shall not perform the NAS transport procedure except for the sending:
      SMS;
      an LPP message;
      a location services message;
      an SOR transparent container;
      a UE policy container;
      a UE parameters update transparent container; or
      a CIoT user data container.

NOTE 2: The contents of CIOT user data container can be data that is not for exception reports, or data that is for exception reports if allowed for the UE (see subclause 6.2.13).

The list of “allowed tracking areas”, as well as the list of “non-allowed tracking areas” shall be erased when:
a) the UE is switched off; and
b) the UICC containing the USIM is removed or an entry of the “list of subscriber data” with the SNPN identity of the SNPN is updated.

When a tracking area is added to the list of “5GS forbidden tracking areas for roaming” or to the list of “5GS forbidden tracking areas for regional provision of service” as specified in the subclauses 5.5.1.2.5 or 5.5.1.3.5, the tracking area shall be removed from the list of “allowed tracking areas” if the tracking area is already present in the list of “allowed tracking areas” and from the list of “non-allowed tracking areas” if the tracking area is already present in the list of “non-allowed tracking areas”.”

FIG. 2 shows an illustrative example showing a UE registration area, RA, where the RA contains a service area identified by TAI #3 such that TAI #3 is considered to be a non-allowed area.

Note that the situation shown in FIG. 2 is just an example of a RA that contains a non-allowed area. In this example, if the UE is in TAI #3, then the UE is not allowed to initiate a 5GSM procedure unless the UE is exempt from this restriction due to e.g. the request being for emergency purposes, or the UE is high priority UE, or the request is for indicating a change of 3GPP PS data off UE status (as described earlier).

The UE may first register on S1 mode (i.e. EPS) and establish a Packet Data Network, PDN, connection. At a later time, the UE may perform its first inter-system change from S1 mode to NI mode (5GS), after which the UE is currently mandated to perform a PDU session modification in order to report its 5GSM capabilities to the Session Mobility Function, SMF, as described in 3GPP TS 24.501 V17.3.0.

The UE's 5GSM message (e.g. the PDU Session Modification Request message) may be rejected by the network due to congestion at the 5GSM level. When this happens, the PDU session modification which is required after the first inter-system change will not be successful and, as such, the UE is later required to perform the procedure (i.e. to send the PDU Session Modification Request message) after the back-off timer expires.

The following is specified in 3GPP TS 24.501 V17.3.0 in line with the description above:

“The purpose of the UE-requested PDU session modification procedure is:

### . . . [SKIP] . . .

e) to indicate to the network the relevant 5GSM parameters and capabilities (e.g. the UE's 5GSM capabilities, whether the UE supports more than 16 packet filters, the maximum data rate per UE for user-plane integrity protection supported by the UE for uplink, the maximum data rate per UE for user-plane integrity protection supported by the UE for downlink and whether the UE requests the PDU session to be an always-on PDU session in the 5GS) for a PDN connection established when in S1 mode, after the first inter-system change from S1 mode to NI mode, if the UE is a UE operating in single-registration mode in a network supporting N26 interface;

### . . . [SKIP] . . .

If the UE needs to initiate the UE-requested PDU session modification procedure to indicate to the network the relevant 5GSM parameters and capabilities (e.g. the UE's 5GSM capabilities, whether the UE supports more than 16 packet filters, the maximum data rate per UE for user-plane integrity protection supported by the UE for uplink, the maximum data rate per UE for user-plane integrity protection supported by the UE for downlink and whether the UE requests the PDU session to be an always-on PDU session in the 5GS) for a PDN connection established when in S1 mode, after the first inter-system change from S1 mode to NI mode, the UE is a UE operating in single-registration mode in the network supporting N26 interface and timer T3396, T3584, T3585 or the back-off timer is running, the UE shall initiate the UE-requested PDU session modification procedure after expiry of timer T3396, T3584 or T3585 or after expiry of the back-off timer.”

A problem with the prior art, as set out above, is the possibility of contradictory behaviour resulting from overlapping TAIs that simultaneously belong to an LADN service area and a non-allowed service area.

The problem results from a common TAI that is considered to be part of the LADN service area information and at the same time also part of the TAI that is considered to be a non-allowed area (or a TAI that is outside an allowed area).

Note that herein, a TAI that is a non-allowed area is to be regarded as equivalent to a TAI that falls outside of an allowed area for the UE, and hence the end-effect is the same.

The problem is further illustrated in FIG. 3. Here, the UE in TAI #3 will end up with contradictory requirements as follows. First, based on the requirements related to LADN service area, the UE can send a 5GSM message to establish a PDU session while the UE remains in TAI #3. At the same time, per the service area restriction requirements, the UE in TAI #3 is not allowed to initiate a 5GSM procedure since TAI #3 is considered to be a non-allowed area. Therefore, a solution is required to tackle these contradictory requirements which can lead to non-standardized UE behaviour and potentially unexpected network behaviour as well, which is highly undesirable.

The following is stated in 3GPP TS24.501, section 5.3.13:

“Over 3GPP access, when the lists are erased, the UE performs cell selection according to 3GPP TS 38.304 or 3GPP TS 36.304. A tracking area shall be removed from the list of “5GS forbidden tracking areas for roaming”, as well as the list of “5GS forbidden tracking areas for regional provision of service”, if the UE receives the tracking area in the TAI list or the Service area list of “allowed tracking areas” in REGISTRATION ACCEPT message or a CONFIGURATION UPDATE COMMAND message. The UE shall not remove the tracking area from “5GS forbidden tracking areas for roaming” or “5GS forbidden tracking areas for regional provision of service” if the UE is registered for emergency services.”

The above states that when the UE receives a TAI that is considered to be an allowed TA, the UE removes that TAI from the “5GS forbidden tracking areas for roaming” as well as the list of “5GS forbidden tracking areas for regional provision of service”. However, nothing is stated regarding the LADN service area i.e. if a TAI is received as part of the LADN service area and the TAI also exists in “5GS forbidden tracking areas for roaming” and/or the list of “5GS forbidden tracking areas for regional provision of service”, the TAI remains in the latter lists and the UE will, in fact, not be able to use LADN service in the TAI. Therefore, keeping the TAI in one or both of these lists is problematic and contradictory.

It is therefore an aim of embodiments of the disclosure to address these and other issues in the prior art.

According to the disclosure, there is provided an apparatus and method as set forth in the appended claims. Other features of the disclosure will be apparent from the dependent claims, and the description which follows.

According to a first aspect of the disclosure, there is provided a method of operating a User Equipment, UE, in communication with a telecommunication network, wherein the UE is provided with a first set of information and a second set of information, the first and second sets relating to the availability of one or more certain services for the UE defined in terms of Tracking Area Identities, TAIs, wherein the UE determines if there is an overlapping TAI present in the first and the second set of information and, if it is so determined, then a rule associated with whichever of the first and second set has been assigned a higher priority applies to the overlapping TAI.

In an embodiment, the first set relates to Service Area restrictions, which relates to service restrictions.

In an embodiment, the second set relates to Local Area Data Network, LADN, service information or a 5GS Tracking Area Identities, TAI, list within the LADN service information.

In an embodiment, the UE is further provided with a third set of information wherein the third set has a different priority than either the first or the second set where the third set optionally includes “5GS forbidden tracking areas for roaming” or “5GS forbidden tracking areas for regional provision of service”.

In an embodiment, when the rule, associated with whichever of the first and second set has been assigned a higher priority, applies to the overlapping TAI, the rule associated with the higher priority set overrides a rule associated with the overlapping TAI in the other set.

In an embodiment, when the rule, associated with whichever of the first and second set has been assigned a higher priority applies to the overlapping TAI, the overlapping TAI is deleted from the lower priority set.

In an embodiment, in the event of an overlap between the first and second sets, the UE perform a registration procedure with the network to request that the network corrects the overlap.

In an embodiment, the first set is assigned a higher priority than the second set.

According to a second aspect of the disclosure, there is provided a UE operable to perform the method of the first aspect.

According to an aspect of the disclosure, there is provided a solution that deals with cases in which the LADN service information and the Service area information (and possibly other lists) contain overlapping tracking area identities (TAIs) which results in contradictory requirements. The disclosure presents a way to avoid these contradictory requirements by giving higher precedence to one of the lists.

According to another aspect of the disclosure, there is provided a system whereby the UE verifies if a TAI that is part of the LADN service information is present in any of the lists of lower priority. If so, the UE should remove the TAI from the lower priority list of areas so as to also avoid contradictory requirements regarding the UE behaviour in an LADN area versus another area with which there is an overlap.

According to a third aspect of the disclosure, there is provided a method of operating a User Equipment, UE, in communication with a telecommunication network, wherein if the UE is in a Local Area Data Network, LADN, area, it can only initiate a NAS procedure if it is in a predetermined state.

In an embodiment, the NAS procedure is one of a 5GSM or 5GMM procedure.

In an embodiment, the 5GSM procedure comprises one of: PDU session establishment procedure with a LADN Data Network Name, DNN, to establish a PDU session for the LADN, a UE-requested PDU session modification procedure to modify the PDU session for the LADN.

In an embodiment, the 5GMM procedure comprises a service request for LADN purposes, including, for instance, a request to set up a User Plane for an LADN PDU session.

In an embodiment, the predetermined state is a 5GMM-REGISTERED.NORMAL-SERVICE state.

In an embodiment, if the UE state changes from the predetermined state to a non-allowed state, then the NAS procedure stops.

In an embodiment the non-allowed state is 5GMM-REGISTERED.NON-ALLOWED-SERVICE.

In an embodiment, if the UE is not in the predetermined state, it must wait until it is in the predetermined state before if it can initiate the NAS procedure.

In an embodiment, if the UE receives new or updated LADN service information, the UE compares a 5GS TAI list within the LADN service information with one or more TAIs in the “5GS forbidden tracking areas for roaming” and/or the list of “5GS forbidden tracking areas for regional provision of service” and removes the one or more TAIs present in the 5GS TAI list and in the “5GS forbidden tracking areas for roaming” and/or the list of “5GS forbidden tracking areas for regional provision of service” from the “5GS forbidden tracking areas for roaming” and/or the list of “5GS forbidden tracking areas for regional provision of service”.

According to a fourth aspect of the disclosure, there is provided a UE operable to perform the method of the third aspect. In an embodiment, the predetermined state is a 5GMM-REGISTERED.NORMAL-SERVICE state.

According to the disclosure, there is provided an apparatus and method as set forth in the appended claims. Other features of the disclosure will be apparent from the dependent claims, and the description which follows.

According to an aspect of the disclosure, there is provided a solution that deals with cases in which the LADN service information and the Service area information (and possibly other lists) contain overlapping tracking area identities (TAIs) which results in contradictory requirements. The disclosure presents a way to avoid these contradictory requirements by giving higher precedence to one of the lists.

According to another aspect of the disclosure, there is provided a system whereby the UE verifies if a TAI that is part of the LADN service information is present in any of the lists of forbidden areas. If so, the UE should remove the TAI from the forbidden list of areas so as to also avoid contradictory requirements regarding the UE behaviour in an LADN area versus a forbidden area.

Although a few preferred embodiments of the disclosure have been shown and described, it will be appreciated by those skilled in the art that various changes and modifications might be made without departing from the scope of the disclosure, as defined in the appended claims.

For a better understanding of the disclosure, and to show how embodiments of the same may be carried into effect, reference will now be made, by way of example only, to the accompanying diagrammatic drawings in which:

FIG. 1 shows an illustration where a UE RA and an LADN Service Area that is part of the RA known in the prior art;

FIG. 2 shows an illustration where a UE RA contains a (non-allowed) Service Area known in the prior art;

FIG. 3 shows an illustration where a UE RA with a TAI (#3) that is considered to be an LADN service area and a non-allowed area at the same time, known in the prior art; and

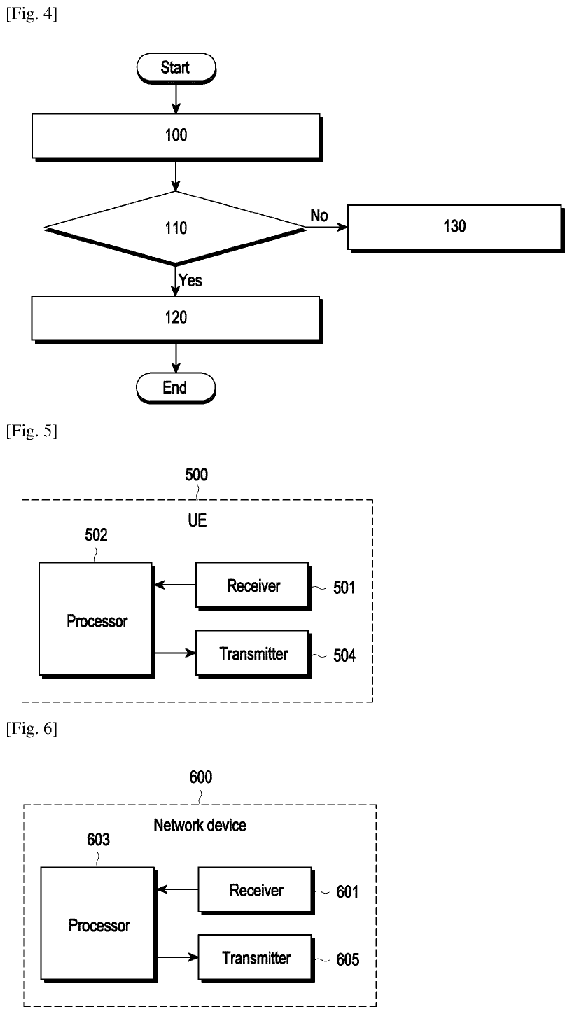

FIG. 4 shows a flowchart illustrating a method according to an embodiment of the disclosure.

Herein, the term a “first list” may refer to the service area list (or service area restriction information, or service area information), where the service area list may represent an allowed area or a non-allowed area. The first list may hence represent the contents of the Service area list Information Element, IE, or the TAIs in the Service area list IE where the TAI may be an allowed area or a non-allowed area (see 3GPP TS 24.501 V17.3.0).

The term a “second list” may refer to the LADN service information and/or the 5GS TAI list within the LADN information (see 3GPP TS 24.501 V17.3.0).

In an embodiment, the UE with (e.g. the UE has or stores or has received) a first list and with a second list determines if there is a TAI that is common to both lists. For example, the UE verifies if there are any overlapping areas (e.g. TAs or TAIs) between the first list and the second list, or between any number of lists.

When (or if) the UE determines that there is an overlap between the lists (e.g. at least between a first list and a second list, where for e.g. the overlap is an overlap in TA(s) or TAI(s)), the UE prioritizes one list over the other e.g. where, by prioritizing one list over the other, the UE considers the TAI in the prioritized list to be valid and hence applies the necessary rules to that TAI according to the expected treatment of the prioritized list, and e.g. the UE further ignoring the presence of the same TAI in the list that is not considered to be prioritized. Optionally the UE considers that the evaluation of the first list (e.g. the service area list) shall take precedence over the evaluation of the second list (e.g. the LADN service information).

For example, if the first list is a service area list and the second list is an LADN service information, the UE verifies if there is a common or same TAI in both lists. If yes, the UE prioritizes the service area list over the LADN service information with respect to the common TAI(s). As such, when the UE is in the common TAI(s), the UE considers the TAI as present in the service area list such that the rules and expected UE behaviour within a service area list apply to the common TAI. Moreover, the UE should optionally not apply the rules of the LADN service information (or the rules of the UE behaviour when the UE is in a TAI that is part of the LADN service information) because the TAI is also present in the service area list. Optionally, the evaluation of the first list (e.g. where the first list is a the service area list or the TAIs in the service area information) shall take precedence over the evaluation of the second list (e.g. where the second list is the LADN service information or the TAI(s) in the LADN service information) in the UE.

Optionally, the UE may further remove the one or more TAI from the list which is not considered to take precedence over the other. For example, the UE may remove the one or more TAIs from the second list if the second list is not the list that is considered to be prioritized or if it is not the list that is considered to be of higher precedence. The UE may remove any TAI, that is considered to be common across the lists or any TAI which is considered to be overlapping across the lists, from one of the lists where optionally the TAI should be removed from the list that is not prioritized or that is not considered to have precedence. Alternatively, the UE may remove any such TAI from both lists.

Alternatively, when the UE determines that there is one or more TAI which overlap, or one or more TAI that is common across two or more lists, the UE may perform a registration procedure (i.e. send a Registration Request message) to the network for which it is then hoped that the network can correct such an overlap. Optionally, the UE can include any indication in the Network Access Stratum, NAS, message (e.g. Registration Request) that informs the network that there is an overlap (or a common set of TAI) across two or more lists. This indication can be a new indication in any form e.g. using a new IE or using an existing IE with a new value, etc. If the network receives a Registration Request optionally with an indication about an overlap or commonality of entries across different lists, the network may verify the contents of the lists that are in the UE's context. The AMF may verify a sub-set of, or all, the lists of the UE and update the lists accordingly such that there is no overlap or conflict, etc. The AMF may then provide the updated lists to the UE in any NAS message such as the Registration Accept or Configuration Update Command message. Note that the procedures herein apply for any lists and are not intended to restrict the applications of these procedures to the service area list and/or the LADN service information only.

In another embodiment, when the UE detects an overlap in the TAIs across the lists e.g. as described above, the UE may be exempted from the service area restrictions if the UE is inside the LADN (service) area and, as such, the UE can perform any NAS procedure (e.g. service request procedure or a 5GSM procedure) if the procedure is related to LADN.

Note that the “first list” may also refer to the “5GS forbidden tracking areas for roaming” and/or the list of “5GS forbidden tracking areas for regional provision of service”, hereafter referred to as the list of Forbidden Areas. As such, the procedures set out above would apply in a similar manner. For example, if there is any overlap in TAs or TAIs across any of the list of Forbidden Areas and the second list (e.g. the LADN service information or its contents of TAIs), then the first list (i.e. in this case the list if Forbidden Areas) shall take precedence over the second list.

Note that, although unrelated to the issue of overlap in TAI, the UE may be in the restricted service area in which the registration procedure is currently allowed. One of the triggers for the registration procedure is to request new LADN information as specified in 3GPP TS 24.501 V17.3.0. Embodiments of the disclosure provide that the UE may first verify if it is in a restricted area and if so, then the UE should not trigger the registration procedure for the purpose of requesting new LADN information since 5GSM procedures are anyways prohibited. However, an exception to this would be if the UE is a high access priority UE or if the UE is configured as a high access priority UE. As such, if the UE is not a high access priority UE, and if the UE requires to get new LADN information, the UE should only perform the registration procedure if the UE is not in a restricted service area i.e. if the UE is not in a non-allowed area or if the UE is in an allowed area.

In another embodiment (e.g. as an alternative way to achieve the above), the UE can prioritize certain lists by further checking other conditions as will be explained in the following.

When the UE has an LADN information and the UE also has a restricted service area information such that the current TAI of the UE is considered to be a non-allowed area (or the current TAI of the UE is not a TAI of an allowed area and hence the UE is not in an allowed area), then the UE should enter substate 5GMM-REGISTERED.NON-ALLOWED-SERVICE (instead of substate 5GMM-REGISTERED.NORMAL-SERVICE) even though the current TAI of the UE is part of the LADN information. As such, when the UE is in an LADN area, the UE needs to further verify if it is in 5GMM-REGISTERED.NON-ALLOWED-SERVICE substate or in 5GMM-REGISTERED.NORMAL-SERVICE substate.
If the UE is in 5GMM-REGISTERED.NON-ALLOWED-SERVICE substate, then the UE cannot perform any procedure for LADN i.e. the UE should not initiate or the UE should block:
Any procedure that is related to LADN such as a service request procedure or any 5GSM procedure (e.g. a procedure to modify or release a PDU session)
If the UE is in 5GMM-REGISTERED.NORMAL-SERVICE substate, then the UE is allowed to perform any of the existing procedures that are permitted for LADN e.g. service request procedure or any 5GSM procedure (e.g. a procedure to modify or release a PDU session for LADN)

As such, the UE can only initiate any of the allowed NAS procedures for LADN (e.g. a service request procedure, or a procedure to modify or release a PDU session for LADN) if the UE is not in any area that is considered to be a non-allowed area or if the UE is not in any area that is considered to be a forbidden area of any type.

When the UE is in a LADN service area, and the UE is not in a Forbidden Area (e.g. a forbidden area of any type) and the UE is not in a non-allowed service area (or the UE is not outside an allowed area or the UE is inside an allowed area), the UE may request a PDU Session Establishment/Modification for any LADN DNN (or for any PDU session for LADN) or may request to activate user plane resources for any existing PDU Session for LADN, or may initiate any NAS procedure for LADN.

To state this in another way, when the UE is in a LADN service area, and the UE is neither in a Forbidden Area (e.g. a forbidden area of any type) nor in a non-allowed service area (or the UE is not outside an allowed area or the UE is inside an allowed area), the UE may request a PDU Session Establishment/Modification for any LADN DNN (or for any PDU session for LADN) or may request to activate user plane resources for any existing PDU Session for LADN, or may initiate any NAS procedure for LADN.

If the UE has overlapping areas between Forbidden Areas, Service Area Restrictions and LADN service area or any combination of them, the UE shall proceed in the following precedence order: The evaluation of Forbidden Areas, Service Area Restrictions shall take precedence over the evaluation of LADN service area.

The UE may give precedence as follows in decreasing priority order: Forbidden Areas, Service Area Restrictions, LADN area. Note that a different order may also be defined and used by the UE.

Note that the procedures set out above can be applied in any combination or in any order. Furthermore, the lists may be inter-changed e.g. where a first list can refer to the contents of a second list, and optionally the second list can refer to the contents of the first list as described above. Furthermore, other lists can also be considered and so the first and/or second list can refer to other lists as well.

A TAI may exist in the “5GS forbidden tracking areas for roaming” and/or the list of “5GS forbidden tracking areas for regional provision of service” that the UE has. When the UE receives a new or updated LADN service information, the UE verifies the 5GS TAI list within the LADN service information versus the TAI(s) in the “5GS forbidden tracking areas for roaming” and/or the list of “5GS forbidden tracking areas for regional provision of service”. For every TAI that is in the LADN service information (i.e. in the 5GS TAI list within the LADN information), if the TAI exists in the “5GS forbidden tracking areas for roaming” and/or the list of “5GS forbidden tracking areas for regional provision of service”, then the UE removes that TAI from the “5GS forbidden tracking areas for roaming” and/or the list of “5GS forbidden tracking areas for regional provision of service”.

As such, a TAI shall be removed from the list of “5GS forbidden tracking areas for roaming”, as well as the list of “5GS forbidden tracking areas for regional provision of service”, if the UE receives (or determines) that the TAI in question is in the 5GS TAI list(s) that is (or are) included in the LADN (information), e.g. which is in turn included in the LADN information IE, that is received by the UE in REGISTRATION ACCEPT message or a CONFIGURATION UPDATE COMMAND message, or any other NAS message.

In other words, a TAI that is part of the LADN information is removed from the list of “5GS forbidden tracking areas for roaming”, as well as the list of “5GS forbidden tracking areas for regional provision of service” if the same TAI is present in any of these lists or in both of these lists. This behaviour is applied by the UE and, as such, the UE is required to make the verification for the condition as described above and then take the proposed action as described above.

The UE behaviour required to address cases in which at least one TAI exists in the LADN service area information and in other lists, such as the Service area list and/or the forbidden area list, has not been described in the prior art and so poses potential problems to the valid operation of UEs and the network. Embodiments of the disclosure provide a clear means of handling such cases so as to avoid contradictory behaviour or requirements for the UE. This also leads to a well predicted UE behaviour when such cases arise. Without this solution, and continuing to act according to the prior art approach, different UEs may behave differently, thereby defeating the purpose of the standards that aims to achieve a predictable system. As such, negative user experience is avoided.

For completeness, FIG. 4 shows a flowchart which illustrates a method according to an embodiment of the disclosure.

A method illustrated in FIG. 4 will be described in consideration of an aspect of the disclosure.

Flow starts at 100 with a UE in receipt of first and second sets of information regarding the availability of one or more certain services for the UE. The information in each of the first and second sets is presented in terms of, at least, Tracking Area Identities, TAIs. However, other representations of location or area information are also possible.

At step 110, a check is made to determine if there is an overlap between first and second sets or lists. This means that any commonality is checked for and identified. Assume the first set includes TAI1, TAI2, TAI3 and TAI4. The second set includes TAI3, TAI4, TAI5 and TAI6. The overlap in such a case is TAI3 and TAI4 i.e. these two TAIs are common to the first and second set and are therefore said to overlap.

In an embodiment, the first set includes service area restrictions and the second set is the LADN set. If there is an overlap, then at 120, priority is given to the overlapping (or common) TAIs of the set with the higher priority The choice of which set takes priority can be defined, as long as one set has clear priority in the event of overlap. This avoids the issue of contradictory instructions.

In the particular example given, in the prior art, a contradiction would be possible with respect to TAI3 and TAI4, and it would be possible to interpret the rules in a manner which would result in uncertain behaviour, since according to the first set a particular service might be available for the UE, but according to the second set, the particular service would not be available.

By clearly defining one set to have priority over the other, it is then clear which rules apply to the overlapping TAIs and, so, which particular service is available in those TAIs.

If there is no overlap, then at 130, operation can continue without any contradictory behaviour.

A method illustrated in FIG. 4 will be described in consideration of another aspect of the disclosure.

Flow starts at 100 with a UE in a Local Area Data Network, LADN, area. At 110, the UE checks to see if it is in a predetermined state, namely a 5GMM-REGISTERED.NORMAL-SERVICE state. If it is, then at 120, the UE is permitted to initiate a 5GSM procedure, such as UE-requested PDU session establishment procedure with a LADN Data Network Name, DNN, to establish a PDU session for the LADN, a UE-requested PDU session modification procedure to modify the PDU session for the LADN, or a service request procedure to re-establish user-plane resources for a PDU session for the LADN.

If the check at 110 is negative, then flow passes to 130 and ends without the UE being permitted to initiate a 5GSM procedure.

If the UE is in a non-allowed state, but receives an LADN request, the UE is not able to act upon such a request (i.e. initiate the 5GSM procedure) but can do so once it is in the 5GMM-REGISTERED.NORMAL-SERVICE state. Similarly, if the UE is in the 5GMM-REGISTERED.NORMAL-SERVICE state, but changes to a non-allowed state, then the related request ceases.

In this context, the 5GSM procedure is any of: PDU Session Establishment Request; or PDU Session Modification Request, or any mobility management (5GMM) procedure, such as a service request for LADN purposes to, for instance, set up the User Plane for an LADN PDU session. Note that the aforementioned are exemplary only and other 5GSM procedures or 5GMM procedures or messages may also be considered and applicable for LADN. More generically, both 5GSM and 5GMM are NAS procedures and an embodiment of the disclosure is only able to initiate such a NAS procedure when in the 5GMM-REGISTERED.NORMAL-SERVICE state.

An internal structure of a UE according to various embodiments of the disclosure is described below with reference to FIG. 5.

FIG. 5 is a block diagram schematically illustrating an internal structure of a UE according to an embodiment of the disclosure.

Referring to FIG. 5, a UE 500 may include a receiver 501, a transmitter 504, and a processor 502. The receiver 501 and the transmitter 504 may collectively be referred to as a transceiver according to an embodiment.

The transceiver may transmit/receive signals to/from a network device (e.g., a base station). The signals may include control information and data. To that end, the transceiver may include an RF transmitter for frequency-up converting and amplifying transmitted signals and an RF receiver for low-noise amplifying and frequency-down converting received signals. The transceiver may receive signals via a radio channel, output the signals to the processor 502, and transmit signals output from the processor 502 via a radio channel.

The processor 502 may control a series of processes for the UE 500 to operate according to the above-described embodiments. The processor 502 may perform overall operations related to an operation of managing overlap between to LADN Service Information and other list. For example, the processor 502 may perform overall operations related to an operation (or an embodiment or an example or an aspect) illustrated in FIG. 1 to FIG. 4. For example, the receiver 501 may receive a signal from another network device (e.g., another base station), and the processor 502 may control the transmitter 504 to transmit a signal to the network device and control the receiver 501 to receive a signal from the network device. Further, the transmitter 504 may transmit a determined signal at a determined time point.

An internal structure of a network device according to various embodiments of the disclosure is described below with reference to FIG. 6.

FIG. 6 is a block diagram schematically illustrating an internal structure of a network device according to an embodiment of the disclosure.

Referring to FIG. 6, a network device 600 may include a receiver 601, a transmitter 605, and a processor 603. The receiver 601 and the transmitter 605 may collectively be referred to as a transceiver according to an embodiment.

The transceiver may transmit/receive signals to/from a UE. The signals may include control information and data. To that end, the transceiver may include an RF transmitter for frequency-up converting and amplifying transmitted signals and an RF receiver for low-noise amplifying and frequency-down converting received signals. The transceiver may receive signals via a radio channel, output the signals to the processor 603, and transmit signals output from the processor 603 via a radio channel.

The processor 603 may control a series of processes for the network device 600 to be able to operate according to the above-described embodiments. The processor 603 may perform overall operations related to an operation of managing overlap between to LADN Service Information and other list. For example, the processor 603 may perform overall operations related to an operation (or an embodiment or an example or an aspect) illustrated in FIG. 1 to FIG. 4.

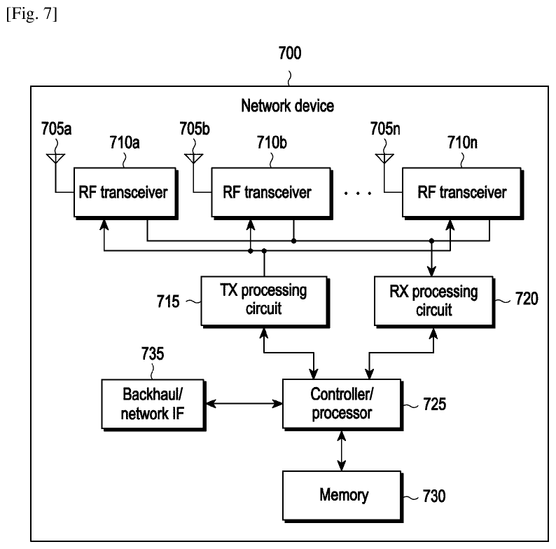

A structure of a network device according to an embodiment is described below with reference to FIG. 7.

FIG. 7 is a diagram schematically illustrating a structure of a network device according to an embodiment of the disclosure.

The embodiment of the network device illustrated in FIG. 7 is for illustrative purposes only, and the scope of the disclosure is not limited thereto.

Referring to FIG. 7, a network device 700 includes a plurality of antennas 705a to 705n, a plurality of radio frequency (RF) transceivers 710a to 710n, a transmit (TX) processing circuit 715, and a receive (RX) processing circuit 720. The network device 700 further includes a controller/processor 725, a memory 730, and a backhaul or network interface 735.

The RF transceivers 710a to 710n receive input RF signals, such as signals transmitted from UEs in the network, through the antennas 705a to 705n. The RF transceivers 710a to 710n down-convert the input RF signals, generating intermediate frequency (IF) or baseband signals. The IF or baseband signals are transmitted to the RX processing circuit 720, and the RX processing circuit 720 filters, decodes, and/or digitizes the baseband or IF signals, generating processed baseband signals. The RX processing circuit 720 sends the processed baseband signals to the controller/processor 725 for further processing.

The TX processing circuit 715 receives analog or digital data, such as speech data, web data, emails, or interactive video game data, from the controller/processor 725. The TX processing circuit 715 encodes, multiplexes, and/or digitizes the output baseband data, generating processed baseband or IF signals. The RF transceivers 710a to 710n receive the processed baseband or IF signals output from the TX processing circuit 715 and up-convert the baseband or IF signals into RF signals which are to be transmitted through the antennas 705a to 705n.

The controller/processor 725 may include one or more processors or other processing devices that control the overall operation of the network device 700. For example, the controller/processor 725 may perform overall operations related to an operation (or an embodiment or an example or an aspect) illustrated in FIG. 1 to FIG. 4. In one example, the controller/processor 725 may control reception of forward channel signals and transmission of reverse channel signals by the RF transceivers 710a to 710n, the RX processing circuit 720, and the TX processing circuit 715 according to known principles. The controller/processor 725 may support additional functions, such as more advanced wireless communication functions.

According to various embodiments, the controller/processor 725 performs overall operations related to an operation of managing overlap between to LADN Service Information and other list. For example, the controller/processor 725 may perform overall operations related to an operation (or an embodiment or an example or an aspect) illustrated in FIG. 1 to FIG. 4.

Further, the controller/processor 725 may support beamforming or directional routing operations in which signals output from the plurality of antennas 705a to 705n are differently weighted to efficiently steer the signals output in a desired direction. Any of other various functions may be supported by the controller/processor 725 in the network device 700.

The controller/processor 725 may also execute programs and other processes, e.g., operating system (OS), resident in the memory 730. The controller/processor 725 may move data as required by a running process to the memory 730 or the outside of the memory 730.

The controller/processor 725 is connected with the backhaul or network interface 735. The backhaul or network interface 735 allows the network device 700 to communicate with other devices or systems over a backhaul connection or over a network. The network interface 735 may support communications over any appropriate wired or wireless connection(s). For example, when the network device 700 is implemented as a part of a cellular communication system (such as a cellular communication system supporting 5G, LTE, or LTE-A), the network interface 735 allows the network device 700 to communicate with other network devices via a wired or wireless backhaul connection. When the network device 700 is implemented as an access point, the network interface 735 allows the network device 700 to communicate with a larger network (e.g., the Internet) via a wired or wireless local area network or a wired or wireless connection. The network interface 735 includes an appropriate structure to support communications through a wired or wireless connection, such as Ethernet or RF transceiver.

The memory 730 is connected to the controller/processor 725. A portion of the memory 730 may include a random access memory (RAM), and another portion of the memory 730 may include a flash memory or a read-only memory (ROM).

Although FIG. 7 illustrates a network device, various changes may be made thereto. As an example, the network device 700 may include any number of such components as illustrated in FIG. 7. As an example, an access point may include a plurality of network interfaces 735, and the controller/processor 725 may support routing functions to route data between different network addresses. Although FIG. 7 illustrates that the network device 700 includes a single instance of the TX processing circuit 715 and a single instance of the RX processing circuit 720, the network device 700 may include multiple instances (e.g., one for each RF transceiver). Various components of FIG. 7 may be combined together, or each component may be further divided or some components may be omitted or, as necessary, more components may be added.

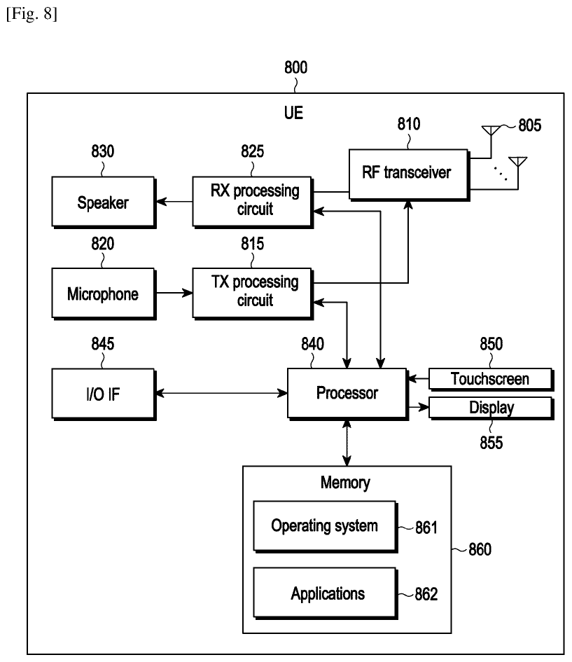

A structure of a UE according to an embodiment is described below with reference to FIG. 8.

FIG. 8 is a view schematically illustrating a structure of a UE according to an embodiment of the disclosure.

The embodiment of the UE illustrated in FIG. 8 is for illustrative purposes only, and the scope of the disclosure is not limited thereto.

Referring to FIG. 8, a UE 800 may include an antenna 805, a radio frequency (RF) transceiver 810, a transmit (TX) processing circuit 815, a microphone 820, and a receive (RX) processing circuit 825. The UE 800 further includes a speaker 830, a processor 840, an input/output (I/O) interface (IF) 845, a touch screen 850, a display 855, and a memory 860. The memory 860 includes an operating system (OS) 861 and one or more applications 862.

The RF transceiver 810 receives an input RF signal transmitted from a network device in a network, via the antenna 805. The RF transceiver 810 down-converts the input RF signal, generating an intermediate frequency (IF) or baseband signal. The IF or baseband signal is transmitted to the RX processing circuit 825, and the RX processing circuit 825 filters, decodes, and/or digitizes the baseband or IF signal, generating a processed baseband signal. The RX processing circuit 825 sends the processed baseband signal to the speaker 830 (e.g., for speech data) or the processor 840 (e.g., for web browsing data) for further processing.

The TX processing circuit 815 receives analog or digital speech data from the microphone 820 or other output baseband data (e.g., web data, emails, or interactive video game data) from the processor 840. The TX processing circuit 815 encodes, multiplexes, and/or digitizes the output baseband data, generating a processed baseband or IF signal. The RF transceiver 810 receives the processed baseband or IF signal output from the TX processing circuit 815 and up-converts the baseband or IF signal into an RF signal which is to be transmitted through the antenna 805.

The processor 840 may include one or more processors or other processing devices, and may execute the OS 861 stored in the memory 860 to control the overall operation of the UE 800. As an example, the processor 840 may control reception of downlink channel signals and transmission of uplink channel signals by the RF transceiver 810, the RX processing circuit 825, and the TX processing circuit 815 according to known principles. According to an embodiment, the processor 840 includes at least one microprocessor or microcontroller.

According to an embodiment, the processor 840 performs overall operations related to an operation of managing overlap between to LADN Service Information and other list. For example, the processor 840 may perform overall operations related to an operation (or an embodiment or an example or an aspect) illustrated in FIG. 1 to FIG. 4.

The processor 840 may execute other processes and programs embedded in the memory 860. The processor 840 may move data into or out of the memory 860 as required by a running process. According to an embodiment, the processor 840 is configured to execute the applications 862 based on the OS 861 or in response to signals received from network devices or the operator. The processor 840 is coupled to the I/O interface 845, and the I/O interface 845 provides the UE 800 with connectability to other devices, e.g., laptop computers and handheld computers. The I/O interface 845 is a communication path between these accessories and the processor 840.

The processor 840 is also connected to the touch screen 850 and the display 855. The operator of the UE 800 may input data into the UE 800 using the touch screen 850. The display 855 may be a liquid crystal display, a light emitting diode display, or other displays capable of rendering text and/or at least limited graphics, such as from websites.

The memory 860 is connected to the processor 840. A portion of the memory 860 may include a random access memory (RAM), and the remainder of the memory 860 may include a flash memory or a read-only memory (ROM).

Although FIG. 8 illustrates a UE, various changes may be made thereto. For example, various components of FIG. 8 may be combined together, each component may be further divided, or some components may be omitted, or other components may be added as necessary. As an example, the processor 840 may be divided into multiple processors, such as one or more central processing units (CPUs) and one or more graphics processing units (GPUs). Although the UE 800 is configured like a mobile phone or a smart phone in FIG. 8, the UE 800 may be configured to operate as a different type of mobile or stationary device.

According to an embodiment, a method of operating a User Equipment, UE, in communication with a telecommunication network, wherein if the UE is in a Local Area Data Network, LADN, area, it can only initiate a NAS procedure if it is in a predetermined state.

According to an embodiment, wherein the NAS procedure is one of a 5GSM or 5GMM procedure.

According to an embodiment, wherein the 5GSM procedure comprises one of: PDU session establishment procedure with a LADN Data Network Name, DNN, to establish a PDU session for the LADN, a UE-requested PDU session modification procedure to modify the PDU session for the LADN.

According to an embodiment, wherein the 5GMM procedure comprises a service request for LADN purposes, including, for instance, a request to set up a User Plane for an LADN PDU session.

According to an embodiment, the predetermined state is a 5GMM-REGISTERED.NORMAL-SERVICE state.

According to an embodiment, wherein if the UE state changes from the predetermined state to a non-allowed state, then the NAS procedure stops.

According to an embodiment, wherein the non-allowed state is 5GMM-REGISTERED.NON-ALLOWED-SERVICE.

According to an embodiment, wherein if the UE is not in the predetermined state, it must wait until it is in the predetermined state before if it can initiate the NAS procedure.

According to an embodiment, wherein if the UE receives new or updated LADN service information, the UE compares a 5GS TAI list within the LADN service information with one or more TAIs in the “5GS forbidden tracking areas for roaming” and/or the list of “5GS forbidden tracking areas for regional provision of service” and removes the one or more TAIs present in the 5GS TAI list and in the “5GS forbidden tracking areas for roaming” and/or the list of “5GS forbidden tracking areas for regional provision of service” from the “5GS forbidden tracking areas for roaming” and/or the list of “5GS forbidden tracking areas for regional provision of service”.

According to an embodiment, a UE operable such that if the UE is in a Local Area Data Network, LADN, area, it can only initiate a NAS procedure if it is in a predetermined state.

According to an embodiment, wherein the predetermined state is a 5GMM-REGISTERED.NORMAL-SERVICE state.

According to an embodiment, a method of operating a User Equipment, UE, in communication with a telecommunication network, wherein the UE is provided with a first set of information and a second set of information, the first and second sets relating to the availability of one or more certain services for the UE defined in terms of Tracking Area Identities, TAIs, wherein the UE determines if there is an overlapping TAI present in the first and the second set of information and, if it is so determined, then a rule associated with whichever of the first and second set has been assigned a higher priority applies to the overlapping TAI.

According to an embodiment, wherein the first set relates to Service Area restrictions, which relates to service restrictions.

According to an embodiment, wherein the second set relates to Local Area Data Network, LADN, service information or a 5GS Tracking Area Identities, TAI, list within the LADN service information.

According to an embodiment, wherein the UE is further provided with a third set of information wherein the third set has a different priority than either the first or the second set where the third set optionally includes “5GS forbidden tracking areas for roaming” or “5GS forbidden tracking areas for regional provision of service”.

According to an embodiment, wherein when the rule, associated with whichever of the first and second set has been assigned a higher priority, applies to the overlapping TAI, the rule associated with the higher priority set overrides a rule associated with the overlapping TAI in the other set.

According to an embodiment, wherein when the rule, associated with whichever of the first and second set has been assigned a higher priority applies to the overlapping TAI, the overlapping TAI is deleted from the lower priority set.

According to an embodiment, wherein in the event of an overlap between the first and second sets, the UE perform a registration procedure with the network to request that the network corrects the overlap.

According to an embodiment, wherein the first set is assigned a higher priority than the second set.

According to an embodiment, a UE operable to perform the method as described above is provided.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The disclosure is not restricted to the details of the foregoing embodiment(s). The disclosure extends to any novel one, or any novel combination, of the features disclosed in this specification (including any accompanying claims, abstract and drawings), or to any novel one, or any novel combination, of the steps of any method or process so disclosed.

1.-15. (canceled)

16. A method performed by a user equipment (UE), the method comprising:
identifying whether the UE is located in a local area data network (LADN) service area based on LADN information;
identifying whether the UE is a substate 5th generation system mobility management (5GMM)-REGISTERED.NORMAL-SERVICE; and
in case that the UE is in the LADN service area and the UE is in the substate 5GMM-REGISTERED.NORMAL-SERVICE, initiating one of:
a UE-requested protocol data unit (PDU) session establishment procedure with a LADN data network name (DNN) to establish a PDU session for an LADN,
a UE-requested PDU session modification procedure to modify the PDU session for the LADN, and
a service request procedure to re-establish user-plane resources for the PDU session for the LADN.

17. The method of claim 16, further comprising:
receiving the LADN information.

18. The method of claim 17, wherein the LADN information is received during a registration procedure or UE configuration update procedure.

19. The method of claim 16, wherein the LADN information includes LADN data network names (DNNs) and LADN service area information.

20. The method of claim 19, wherein the LADN service area information includes a set of tracking areas that belong to a registration area.

21. The method of claim 16, further comprising:
in case that the UE is outside the LADN service area, initiating one of:
a UE-requested PDU session release procedure to release the PDU session for the LADN, and
a UE-requested PDU session modification procedure to indicate a change of 3rd generation partnership project (3GPP) packet-switch (PS) data off UE status.

22. The method of claim 21, further comprising:
receiving the LADN information.

23. The method of claim 22, wherein the LADN information is received during a registration procedure or UE configuration update procedure.

24. The method of claim 21, wherein the LADN information includes LADN data network names (DNNs) and LADN service area information.

25. The method of claim 24, wherein the LADN service area information includes a set of tracking areas that belong to a registration area.

26. A user equipment (UE), comprising:
a transceiver; and
at least one processor operably connected to the transceiver,
wherein the at least one processor is configured to:
identify whether the UE is located in a local area data network (LADN) service area based on LADN information,
identify whether the UE is a substate 5th generation system mobility management (5GMM)-REGISTERED.NORMAL-SERVICE, and
in case that the UE is in the LADN service area and the UE is in the substate 5GMM-REGISTERED.NORMAL-SERVICE, initiate one of:
a UE-requested protocol data unit (PDU) session establishment procedure with a LADN data network name (DNN) to establish a PDU session for an LADN,
a UE-requested PDU session modification procedure to modify the PDU session for the LADN, and
a service request procedure to re-establish user-plane resources for the PDU session for the LADN.

27. The UE of claim 26, wherein the at least one processor is further configured to:
receive the LADN information via the transceiver.

28. The UE of claim 27, wherein the LADN information is received during a registration procedure or UE configuration update procedure.

29. The UE of claim 26, wherein the LADN information includes LADN data network names (DNNs) and LADN service area information.

30. The UE of claim 29, wherein the LADN service area information a set of tracking areas that belong to a registration area.

31. The UE of claim 26, wherein the at least one processor is further configured to:
in case that the UE is outside the LADN service area, initiate one of:
a UE-requested PDU session release procedure to release the PDU session for the LADN, and
a UE-requested PDU session modification procedure to indicate a change of 3rd generation partnership project (3GPP) packet-switch (PS) data off UE status.

32. The UE of claim 31, wherein the at least one processor is further configured to:
receive the LADN information via the transceiver.

33. The UE of claim 32, wherein the LADN information is received during a registration procedure or UE configuration update procedure.

34. The UE of claim 31, wherein the LADN information includes LADN data network names (DNNs) and LADN service area information.

35. The UE of claim 34, wherein the LADN service area information a set of tracking areas that belong to a registration area.
